(19) United States
(12) Patent Application Publication
(10) Pub. No.: US 2025/0242788 A1
(43) Pub. Date: Jul. 31, 2025

(54) ELECTROMECHANICAL BRAKE ACTUATOR (EMB) FOR A FRICTION BRAKE OF A VEHICLE AND A METHOD FOR OPERATING SUCH A BRAKE ACTUATOR

(71) Applicant: Robert Bosch GmbH, Stuttgart (DE)

(72) Inventors: Dietmar Kratzer, Tamm (DE); Andrej Gardt, Abstatt (DE); Bernd Lutz, Kempten (DE); Janos Tamas Csoti, Steinheim An Der Murr (DE); Mark Boehm, Lehrensteinsfeld (DE); Martin Winkler, Sonthofen (DE)

(21) Appl. No.: 18/918,324

(22) Filed: Oct. 17, 2024

(30) Foreign Application Priority Data
Jan. 31, 2024 (DE) 10 2024 200 856.7

(51) Int. Cl. B60T 13/74; B60T 8/17; F16D 63/00; F16D 65/16; F16D 127/06

(52) U.S. Cl. CPC B60T 13/746; B60T 8/17; F16D 63/006; F16D 65/16; B60T 2220/04; F16D 2127/06

(57) ABSTRACT

A method for operating an electromechanical brake actuator (EMB) for a friction brake of a vehicle. A locking actuator of the EMB is controlled to lock the mechanics of the EMB when a drive of the EMB has moved the mechanics to a braking position and a standstill of the friction brake is detected.

### CROSS REFERENCE

The present application claims the benefit under 35 U.S.C. § 119 of German Patent Application No. DE 10 2024 200 856.7 filed on Jan. 31, 2024, which is expressly incorporated herein by reference in its entirety.

### FIELD

The present invention relates to a method for operating an electromechanical brake actuator (EMB) for a friction brake of a vehicle, a corresponding computer program product, and an electromechanical brake actuator (EMB) for a friction brake of a vehicle.

### BACKGROUND INFORMATION

An electromechanical brake actuator can provide a braking force to a friction brake via a drive and mechanics. The drive is energized for as long as the braking force is being requested. When the drive is de-energized, the braking force decreases or ceases.

An electromechanical brake actuator can therefore comprise a force accumulator for a parking brake. The force accumulator can be a pretensioned spring, for example, that is released when the vehicle is parked. A vehicle can thus be protected from rolling away even when the brake actuator is de-energized. The force accumulator can be pretensioned again by backward operation of the electromechanical brake actuator when the parking brake is released.

### SUMMARY

The present invention provides a method for operating an electromechanical brake actuator (EMB) for a friction brake of a vehicle, an electromechanical brake actuator (EMB) for a friction brake of a vehicle and a corresponding computer program product. Advantageous further developments and improvements of the approach presented here will emerge from the description and in the rest of the disclosure herein.

In an electromechanical brake actuator, a drive movement of an electric motor is reduced by a gearing in order to obtain a large braking force on friction linings of a friction brake with a small movement of the friction linings. The braking force presses the friction linings against a counterpart, for example a brake disc or brake drum, in order to create friction. The gearing can be a worm gear, for example, that acts on a threaded spindle to convert a rotation into a translation. To press the friction linings onto the counterpart, the gearing is moved in a forward movement. To lift the friction linings away from the counterpart, the gearing is moved in a backward direction. The gearing can also be moved backward by a counterforce when the electric motor no longer provides drive torque. The counterforce can be produced by a lateral runout of the brake disc, for example.

When a vehicle is braked to a standstill using the electromechanical brake actuator, the electric motor has already moved the friction linings at the beginning of the braking operation and pressed them against their counterpart with a required braking force.

In the approach presented here according to an example embodiment of the present invention, after the vehicle has come to a standstill, the friction linings are held at least approximately in the position they reached during the braking process in order to provide a holding torque on the counterpart via the friction linings. To achieve this, the backward movement of the gearing is prevented by a switchable blocking mechanism.

The approach presented here makes it possible for the electric motor to end or at least reduce the provision of drive torque after the vehicle has come to a standstill. Unintended rolling of the vehicle is reliably prevented until the blocking of the gearing is removed. When the vehicle starts moving intentionally, the holding torque or the braking torque can be reduced or decreased in a controlled manner by the electric motor which is once again in operation.

According to a first aspect of the present invention, a method for operating an electromechanical brake actuator (EMB) for a friction brake of a vehicle is presented, wherein a locking actuator of the EMB is controlled to lock the mechanics of the EMB when a drive of the EMB has moved the mechanics to a braking position and a standstill of the friction brake is detected.

According to a second aspect of the present invention, an electromechanical brake actuator (EMB) for a friction brake of a vehicle is provided, wherein the EMB comprises an electric drive, mechanics for transmitting a drive movement of the drive to a friction brake of the vehicle and an electromechanical locking actuator for locking the mechanics.

Ideas concerning embodiments of the present invention may be regarded as being based, among other things, on the thoughts and findings described below.

An electric drive of an electromechanical brake actuator can, for example, be an electric motor that provides a rotational movement and a torque when it is electrically controlled. The mechanics can be a gearing. The mechanics can have a transmission ratio to convert a large input movement of the electric drive into a small output movement of a friction lining of a friction brake, wherein a low input force of the drive is translated into a large output force on the friction lining. The drive can move the friction lining(s) from a starting position to a braking position. In the braking position, the friction linings are in contact with a counterpart of the friction brake, are pressed against the counterpart with a resulting braking force, and create friction there. The counterpart can be a brake disc or a brake drum, for example.

According to an example embodiment of the present invention, an electromechanical locking actuator can be controlled by means of an electrical control signal. The locking actuator can, for instance, comprise an electromagnetic drive. The locking actuator can act on at least one movable locking element. The locking element can engage in a corresponding counterpart of the mechanics to mechanically lock the mechanics. Activating the locking actuator thus makes it possible to lock the mechanics of the EMB in its current state in order to prevent the friction linings that have been moved by the EMB to the braking position from moving back to a non-braking position. In other words, the EMB can be locked and held in its braking configuration by activating the locking actuator.

According to an example embodiment of the present invention, a standstill of the friction brake can be detected by a sensor. In a vehicle, for example, the sensor can be a speed sensor and/or an ABS sensor. The friction brake can in particular be monitored for movement continuously or repeatedly, for instance by monitoring moving components in the brake or a braked wheel itself, or by monitoring other state variables from which the current movement behavior of the friction brake can be deduced. As soon as it is determined that the friction brake or the thus braked vehicle has come to a standstill, the locking actuator is activated immediately or as quickly as possible to lock the mechanics of the EMB.

A driving force generated by the drive can be at least reduced in response to the locking of the mechanics. The drive can in particular be de-energized in response to the locking of the mechanics. The driving force can fall rapidly. The driving force can fall to zero. The drive can be switched off. Energy can be saved by reducing the driving force.

The mechanics can be unlocked again in response to an actuation of an accelerator pedal of the vehicle. An accelerator pedal can be referred to as a gas pedal. Actuation of the accelerator pedal indicates a driver request to continue or start driving. When the accelerator pedal is actuated, torque is provided by a drive of the vehicle. The torque can compensate a reduction in braking force when the mechanics are unlocked.

The drive of the electromechanical brake actuator can be controlled in response to the unlocking of the mechanics to move the mechanics to a starting position. The drive can pull the friction linings away from the counterpart to prevent grinding. Alternatively or additionally, the friction linings can be pushed away from the counterpart by a lateral runout of the counterpart.

According to an example embodiment of the present invention, the locking actuator can comprise at least one switchable locking pawl as the locking element. A latching device for latching the locking pawl can be coupled to the mechanics as the counterpart. A locking pawl can be movable. The locking pawl can be moved by the locking actuator between an unlocked state or an unlocking position and a locked state and a locking position. The locking pawl can be coupled to a housing of the EMB. The locking pawl can thus be supported by the housing when the mechanics are locked.

The latching device can be disposed on a drive side of the mechanics. The electric drive can be coupled to the mechanics on the drive side. On the drive side, the mechanics can be blocked or locked with little force.

The locking pawl and the latching device can create a switchable freewheel to prevent a backward movement of the mechanics, wherein a forward movement is not locked in the activated state of the freewheel as well. In the forward direction, the locking pawl can slide off angled sides of notches of the latching device and, after sliding off, click into place on steep sides of the notches.

According to an example embodiment of the present invention, the latching device can be undercut. A forward pulse of the drive may be needed to unlatch the locking pawl. The steep sides of the notches of the latching device can all have an undercut. When latching, the locking pawl can slide into the undercut in the backward direction and rest stably in the undercut. In the undercut, the locking pawl cannot move back to the unlocked position without the latching device being moved slightly in the forward direction which moves the locking pawl out of the undercut.

The locking actuator can be open when de-energized. The locking actuator can be actively energized to lock the mechanics. The locking actuator can be monostable. The locking actuator or the locking pawl can be held in the unlocked state by a spring, for example. The unlocked state can therefore be the stable state. When energized, the locking actuator can act against the spring and move the locking pawl to the locked state. When the locking pawl is in the locked state and the locking actuator is de-energized, the spring pulls the locking actuator or the locking pawl back to the unlocked state unless the locking pawl is held in the locked state by a mechanical obstacle of the latching device. The obstacle can be the undercut on the latching device, for example. In the locked state, the locking pawl can be stable as a result of a mechanical blockage caused by the undercut as long as the undercut holds the locking actuator. If the undercut is actively removed, i.e. the latching device is actively moved against the blocked direction, the spring pulls the locking pawl or the locking actuator back to the unlocked state.

To unlock the mechanics, the drive can be controlled to move the mechanics in the forward direction at least around the undercut of the latching device for the locking actuator. The locking pawl of the locking actuator can be held securely behind the undercut of the latching device without current when locking the mechanics. The locking pawl cannot come out from behind the undercut without a slight movement of the latching device. To release the locking pawl from the undercut, the drive can temporarily press the friction linings more firmly against the counterpart in order to release the locking pawl. After release, the drive can drive the latching device in the backward direction to lift the friction linings away from the counterpart.

When locking, the mechanics can be moved out of the braking position in the backward direction at least around the undercut. When the locking pawl clicks into place in the latching device, the brake can be released slightly until the locking pawl has clicked into place behind the undercut.

According to an example embodiment of the present invention, the method is preferably computer-implemented and can be implemented in software or hardware, for instance, or in a mixed form of software and hardware, for example in a driver assistance system.

The approach presented here according to the present invention also provided a control unit, wherein the control unit is configured to carry out, control or implement the steps of a variant of the method presented here in corresponding devices.

The control unit can be an electrical device with at least one computing unit for processing signals or data, at least one memory unit for storing signals or data, and at least one interface and/or one communication interface for reading in or outputting data embedded in a communication protocol. The computing unit can, for instance, be a signal processor, a so-called system ASIC or a microcontroller for processing sensor signals and outputting data signals as a function of the sensor signals. The memory unit can be a flash memory, an EEPROM or a magnetic memory unit, for example. The interface can be configured as a sensor interface for reading in the sensor signals from a sensor and/or as an actuator interface for outputting the data signals and/or control signals to an actuator. The communication interface can be configured to read in or output the data wirelessly and/or by wire. The interfaces can also be software modules that are provided on a microcontroller alongside other software modules, for example.

A computer program product or a computer program comprising program code that can be stored on a machine-readable carrier or storage medium, such as a semiconductor memory, a hard disk memory or an optical memory, and can be used to carry out, implement and/or control the steps of the method according to one of the above-described embodiments is advantageous as well, in particular when the program product or program is executed on a computer, in a control unit or an apparatus.

It should be noted that some of the possible features and advantages of the present invention are described here with reference to different example embodiments. A person skilled in the art will recognize that the features of the control unit and the method can be suitably combined, adapted, or interchanged to arrive at further embodiments of the present invention.

### BRIEF DESCRIPTION OF THE DRAWINGS

Embodiments of the present invention are described in the following with reference to the figures, wherein neither the figures nor the description are to be construed as limiting the present invention.

FIG. 1 shows a decision chain of a method according to an embodiment example of the present invention.

FIG. 2 shows a sectional view through an electromechanical brake actuator according to an embodiment example of the present invention.

FIG. 3 shows a spatial illustration of an electromechanical brake actuator according to an embodiment example of the present invention

The figures are merely schematic and are not to scale. Identical reference signs denote identical or functionally identical features.

### DETAILED DESCRIPTION OF EXAMPLE EMBODIMENTS

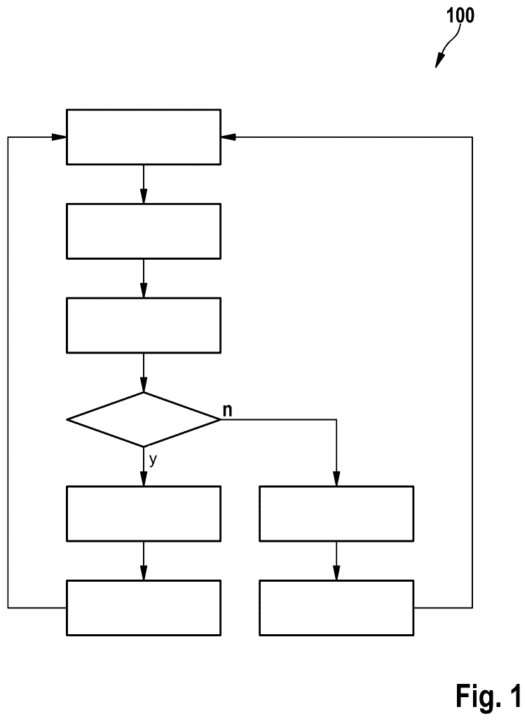

FIG. 1 shows a decision chain 100 of a method for operating an electromechanical brake actuator of a vehicle according to an embodiment example. At the beginning, the vehicle is driving. If a service brake of the vehicle has been actuated and the vehicle has stopped, a hill hold function of the service brake is activated. If the start/stop button of the vehicle remains activated, the driver seat remains occupied and the door remains closed during this time a “short stop” situation is identified, and a locking actuator of the electromechanical brake actuator is quickly closed to lock the friction brake in the position for the hill hold function. An electric drive of the electromechanical brake actuator is then switched off and the active hill hold function is thus ended. If an accelerator pedal of the vehicle is actuated, the short stop is ended and the locking actuator is deactivated so that the brake releases and the vehicle can move.

If the start/stop button is deactivated after the hill hold function is activated, the driver's seat is vacated and/or the door is opened and/or a start/stop automatic of the vehicle switches the engine off, the “parked” situation is identified and the locking actuator is closed for parking. The drive of the electromechanical brake actuator is then switched off and goes into a rest position. The hill hold function is ended as well. Parking is ended when the start/stop button is actuated, the driver seat is occupied and the door is closed again after opening. This also signals the beginning of driving.

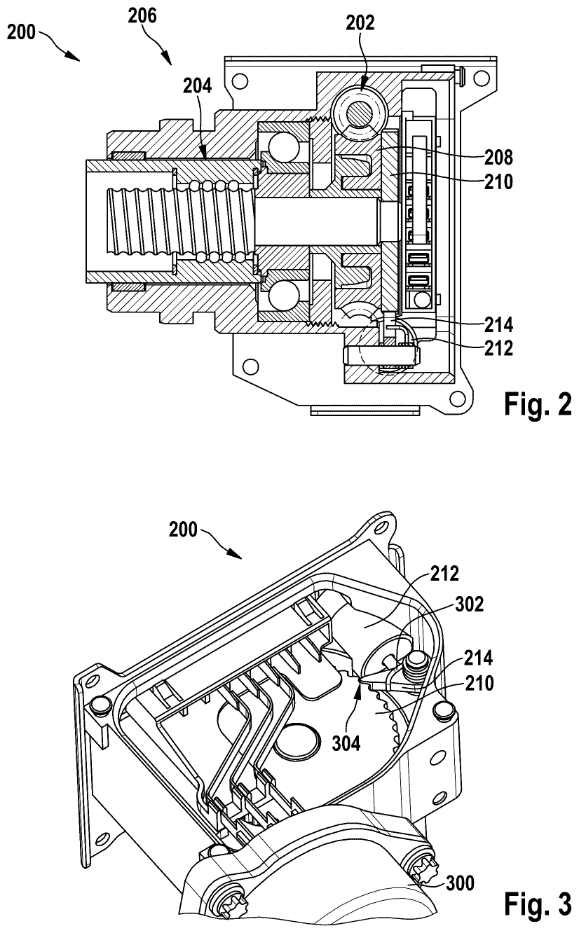

FIG. 2 shows a sectional view through an electromechanical brake actuator 200 according to an embodiment example. The electromechanical brake actuator 200 is abbreviated to EMB 200. The EMB 200 comprises an electric drive. The drive acts on a worm gear 202. The worm gear 202 is coupled to a screw drive 204. A speed of the drive is significantly reduced in the worm gear 202. In the screw drive 204, the reduced rotational movement is converted into a linear movement and a braking force is amplified via a thread pitch. The screw drive 204 is configured as a ball screw drive. The worm gear 202 and the screw drive form the mechanics 206 of the electromechanical brake actuator 200.

A latching device 210 is coupled to a worm wheel 208 of the worm gear 202. A locking actuator 212 with a movable locking pawl 214 is aligned with the latching device 210. The locking actuator 212 is configured to latch the locking pawl 214 on the latching device 210 and thus block the mechanics 206.

In one embodiment example, the locking pawl 214 is configured to block a backward movement of the mechanics 206 and continue to enable a forward movement of the mechanics 206.

FIG. 3 shows a spatial illustration of an electromechanical brake actuator 200 according to an embodiment example. The brake actuator 200 substantially corresponds to the brake actuator in FIG. 2. Shown here are the locking actuator 212, the locking pawl 214, the latching device 210 and an electric drive 300 of the electromechanical brake actuator 200.

The latching device 210 is configured as a gear wheel with a sawtooth toothing. The locking pawl 214 is configured as a movable finger that slides over angled flanks of the toothing when the latching device 210 is rotated in the forward direction and clicks into place on steep flanks of the toothing when the latching device 210 is rotated in the backward direction.

When the locking actuator 212 is activated, it presses against the locking pawl 214 with a force and pushes the locking pawl 214 out of an unlocked position to a locking position. The locking actuator acts against a return spring 302 of the locking pawl 214. If the force is greater than a spring force of the return spring 302, the locking pawl 214 is moved to the locking position. If the force is less than the spring force, the return spring 302 moves the locking pawl 214 back to the unlocked position.

In one embodiment example, the toothing of the latching device 210 is undercut. Therefore, in the locking position, the locking pawl 214 slides into the undercut 304 of at least one notch of the latching device 210 or a tooth of the latching device 210 when the drive 300 reduces its torque. The latching device 210 rotates around the undercut 304 in the backward direction and only then is it locked by the locking pawl 214. When the locking pawl 214 is clicked into place behind the undercut 304, the force of the return spring 302 is too small to move the locking pawl 214 back to the unlocked position.

To move the locking pawl 214 back to the unlocked position, the drive 300 rotates the entire mechanics 206 with the latching device in the forward direction at least around the undercut 304. The locking pawl 214 slides out of the undercut 304 and the return spring 302 pulls the locking pawl 214 back to the unlocked position.

Possible embodiments of the present invention are summarized again below or presented with a slightly different choice of words.

An electromechanical brake actuator (EMB) with a fast transition from a hill hold function to an automatic parking brake (APB) is presented.

In the course of the increasing electrification of units in motor vehicles, the service brake is now coming into focus, too, after the parking brake. Some concepts of electromechanical brakes have already been installed in series-produced vehicles.

Most often, an electric drive motor is combined with one or more gear stages with a very high total reduction ratio; usually with toothed gear mechanisms with a linear transmission ratio. Some concepts use curves as a transmission element and therefore have a non-linear transmission ratio.

In the approach presented here, the “automatic parking brake” (APB) function is also integrated into this EMB. The automatic parking brake has specific requirements, some of which are very different from those for the EMB service brake. The APB is typically designed for long periods of time and usually needs operating current only to change its state. Little or no operating current is needed to maintain an APB state (APB open+vehicle moving or APB closed+vehicle stationary).

In particular in vehicles with EMB, the hill hold function is (usually) realized by an active (energized) holding of the position of the EMB drive motor. This requires high currents that strain the vehicle's storage battery to such an extent that the driving range shrinks.

The approach presented here makes it possible to conserve electrical energy in battery electric vehicles (BEV) with electromechanical brakes (EMB) and thus enable a longer range.

The core idea here is the extremely fast transition of the vehicle holding function from the hill hold function (this is assigned to the rolling vehicle and is implemented by the service brake) to the automatic parking brake function (implemented by the APB automatic parking brake/parking brake which is usually already actuated electromechanically).

This is facilitated by the functional proximity of the parking brake (electromechanical actuation) and the function brake (electromechanical actuation) in the EMB.

The approach presented here makes it possible to save electricity for more range.

The APB can take over the brake that has already been closed by the service brake (hill hold) in the “closed” state. Only a small APB actuation current is needed and the time required for the transition from APB open to APB closed is close to zero or very short.

The operating current for the EMB drive motor can now immediately be reduced from high holding currents to zero. The EMB service brake can be released completely (low reverse currents) or can remain in a position close to the transfer position to APB (low or no holding current because there is no force). The motor of the EMB can therefore be designed to be significantly smaller than conventional motors because it cannot overheat as a result of a continuous current load.

Based on other signals in the vehicle (e.g. vehicle remains in operation (no “stop” button, no vacating of the driver seat (seat sensor), no door opening (door sensor) etc.), it can be inferred that the vehicle has come to a brief stop, e.g. at an intersection, a traffic light, etc.

This situation can alternatively/optionally be defined as “APB closed/short stop”, possibly with effects on other vehicle functions.

If, based on the other signals in the vehicle, it is detected that the vehicle is being parked (“stop” button pressed, vacating the driver seat (seat sensor), etc.), the EMB can return to its rest position without power and with low currents because the APB is already actuated.

This situation can alternatively/optionally be defined as “APB closed/parked”, possibly with effects on other vehicle functions.

The approach presented here can also be used in mechanical-hydraulic actuating elements, even outside the motor vehicle, e.g. in mobile hydraulics and other hydraulics, motorcycles, eBikes, power tools, household appliances, industrial technology, building technology or consumer goods.

At the beginning, the vehicle is driving. Then the signal indicating that the service brake is actuated and the vehicle is stopped is received. The hill hold function then starts. If other signals are on “YES”, e.g.: “start” button remains pressed, driver seat remains occupied, door remains closed, an “APB closed/short stop” situation is identified and the APB is quickly closed, the EMB is opened, and if possible de-energized, and the hill hold function is ended.

The situation is ended by actuating the accelerator pedal (=short stop, continued driving).

If the other signals are on “No”, an “APB closed/parked” situation is identified and the APB is closed for parking, the EMB is opened and goes to the rest position and the hill hold function is ended.

The situation is ended by the “start” button and when the driver seat is occupied and when the door is closed again after opening. (=parking ended, beginning of driving)

Lastly, it should be noted that terms such as “comprising”, “including”, etc. do not exclude other elements or steps and terms such as “one” or “a” do not exclude a plurality.

What is claimed is:

1. A method for operating an electromechanical brake actuator (EMB) for a friction brake of a vehicle, the method comprising the following:
controlling a locking actuator of the EMB to lock mechanics of the EMB when a drive of the EMB has moved the mechanics to a braking position and a standstill of the friction brake is detected.

2. The method according to claim 1, wherein a driving force generated by the drive is at least reduced in response to the locking of the mechanics.

3. The method according to claim 2, in which the drive is de-energized in response to the locking of the mechanics.

4. The method according to claim 1, wherein the mechanics are unlocked in response to an actuation of an accelerator pedal of the vehicle.

5. The method according to claim 4, wherein the drive is controlled in response to the unlocking of the mechanics to move the mechanics to a starting position.

6. The method according to claim 4, wherein, to unlock the mechanics, the drive is controlled to move the mechanics in a forward direction at least around an undercut of a latching device for the locking actuator.

7. The method according to claim 6, wherein, when locking, the mechanics are moved out of the braking position in a backward direction at least around the undercut.

8. An electromechanical brake actuator (EMB) for a friction brake of a vehicle, wherein the EMB comprises:
an electric drive;
mechanics configured to transmit a drive movement of the drive to a friction brake of the vehicle; and
an electromechanical locking actuator configured to lock the mechanics.

9. The EMB according to claim 8, wherein in which the locking actuator is open when de-energized.

10. The EMB according to claim 8, wherein the locking actuator includes at least one switchable locking pawl and a latching device configured to latch the locking pawl is coupled to the mechanics.

11. The EMB according to claim 10, wherein the latching device is disposed on a drive side of the mechanics.

12. The EMB according to claim 10, wherein the locking pawl and the latching device create a switchable freewheel to prevent a backward movement of the mechanic, wherein a forward movement is not locked in an activated state of the freewheel as well.

13. The EMB according to claim 10, wherein the latching device is undercut, wherein a forward pulse of the drive is needed to unlatch the locking pawl.

14. A control unit configured to operate an electromechanical brake actuator (EMB) for a friction brake of a vehicle, the control unit configured to:
control a locking actuator of the EMB to lock mechanics of the EMB when a drive of the EMB has moved the mechanics to a braking position and a standstill of the friction brake is detected.

15. A non-transitory machine-readable storage medium on which is stored a computer program for operating an electromechanical brake actuator (EMB) for a friction brake of a vehicle, the computer program, when executed by a processor, causing the processor to perform:
controlling a locking actuator of the EMB to lock mechanics of the EMB when a drive of the EMB has moved the mechanics to a braking position and a standstill of the friction brake is detected.
